(19) United States
(12) Patent Application Publication
(10) Pub. No.: US 2008/0258036 A1
(43) Pub. Date: Oct. 23, 2008

(54) SYSTEM FOR DIMENSIONAL STABILITY OF ELASTOMERIC MICRODEVICES

(75) Inventor: Mark C. Peterman, Fremont, CA (US)

Correspondence Address: MARK C. PETERMAN, P.O. BOX 142, FREMONT, CA, 94537, US

(73) Assignee: Labrador Research LLC, Fremont, CA (US)

(21) Appl. No.: 12/058,702

(22) Filed: Mar. 29, 2008

Related U.S. Application Data
(60) Provisional application No. 60/909,331, filed on Mar. 30, 2007.

(51) Int. Cl. B29C 39/40

(52) U.S. Cl. 249/82

(57) ABSTRACT

Disclosed is a fixture device for maintaining fabrication of precise elastomeric microdevices. The fixture may be used to maintain dimensional stability of elastomeric devices during temperature cycling. Furthermore, the fixture may be used to control geometry during temperature cycling due to thermal curing. The fixture may be loaded into equipment for precise alignment and assembly of elastomeric devices. The fixture is particularly useful for building precise microdevices from polymeric or elastomeric materials.

### CROSS REFERENCE TO RELATED APPLICATIONS

This application is related to and claims priority from U.S. Provisional Application 60/909,331 filed on Mar. 30, 2007, hereby incorporated by reference.

### BACKGROUND OF THE INVENTION

1. Field of Invention

This invention generally relates to microfabrication. In particular it relates to fabricating elastomeric devices.

2. Prior Art

The use of elastomeric materials (materials constructed from elastomers) is revolutionizing low-volume microfabrication. We define these microfabrication techniques generically as soft lithography. Soft lithography begins with a master, often created by traditional photolithography, although any patterned surface may be used. Typically, a prepolymer is cast against this master to yield a relief pattern in the polymer. Once the prepolymer is cross-linked, the elastomeric stamp may be removed from the mold and used in a variety of applications.

Soft lithography has numerous applications in biomedical research (Annual Review of Biomedical Engineering, vol. 3, pg. 335-373, 2001). The powers of soft lithography are the ease with which devices are created and the lower cost of these devices when compared to conventional semiconductor manufacturing (Annual Review of Materials Science, vol. 28, pg. 153-184, 1998). As many of these devices are produced in small numbers, using high-volume silicon foundries is not a reasonable approach. Additionally, many soft lithography applications use the benefits provided by the elastomeric materials—deformability, adhesion, surface treatments, and high-resolution mold reproduction—to achieve their purpose. These benefits are not provided by traditional semiconductor materials.

Soft lithography includes dozens of applications, such as microcontact printing, micromolding in capillaries, microtransfer molding, replica molding, near-field phase shift lithography, solvent-assisted microcontact molding, and microfluidics. These techniques take advantage of the material properties of elastomers to accomplish new microfabrication methods and to improve upon existing methods. At this time, soft lithographic techniques are well-suited for small-volume and research-level microfabrication. With improved manufacturing tools, these techniques will enter commercial biomedical research markets.

One example of soft lithography, microcontact printing, takes advantage of the conformal nature of PDMS. This technique begins with a patterned stamp, a piece of PDMS with a micropatterned relief on one side. If necessary, the stamp is treated with an oxygen plasma, and then inked with a material of choice. This inked stamp is pressed against a substrate, transferring the pattern. The process is similar in simplicity to a common office stamp pad, only with submicron features.

Microcontact printing has been used to pattern many materials, from biomolecules to metals. These printed materials have then been used for cell growth, self-assembled monolayers, carbon nanotubes, metallic interconnects, DNA, and proteins, to name a few (IBM Journal of Research and Development, vol. 45, pg. 697-719, 2001).

A second application of elastomers in microfabrication is through multilayer microfluidics. We highlight two different uses of multilayer microfluidics. The first approach from U.S. Pat. No. 6,408,878 consists of three-layer elastomeric devices. The bottom layer contains the fluidic channels and the top layer contains control channels. A thin sheet of elastomer separates the top and bottom layers. When an upper layer channel is pressurized, the thin middle layer is pushed down, closing off the lower channel. This valve enables novel devices, including micro-peristaltic pumps.

The second approach consists of many layers of channels, each providing a single fluid ejection point, is shown in US Patent Application 20070231458. The layers contain a linear array of fluidic channel, with each channel flowing past the edge of the device at a single point. Many stacked layers create a two-dimensional array of fluid spotting points. These devices are used for printing biomolecules on substrates.

To date, both approaches are done manually, using a stereo-zoom microscope to see the features and manual manipulation of the materials. This approach limits the resolution and complexity in the first approach, and the speed of manufacturing for the second approach. The hand manipulation of the elastomer introduces many errors and challenges to the fabrication process.

Elastomers are useful materials for a wide range of reasons: deformability, adhesion, surface treatments, and high-resolution mold reproduction. The ability to reproduce minute features in a photoresist pattern allows for straightforward and rapid device fabrication at the nanometer-scale; the master-making process is the resolution limiting step. One popular elastomer, PDMS, is naturally hydrophobic, a useful property for self-assembled monolayer efforts. This property, however, is not useful for water-based inks, such as solutions of DNA or proteins. With a simple oxygen plasma treatment, PDMS is readily converted to a hydrophilic state. The adhesion of PDMS to glass or another piece of PDMS allows for the creation of multilayer devices. This adhesion is reversible, although the application of oxygen plasma can make the adhesion irreversible. Finally, the deformability of the materials allows application of the material to uneven surfaces; PDMS readily conforms to even highly non-uniform surfaces.

For example, elastomers may be used as a protective layer during semiconductor processing steps. The fixture shown in U.S. Pat. No. 4,861,452 allows an elastomeric pad to protect the backside of a silicon wafer during processing.

These are powerful benefits of this elastomer; however, these benefits can also be a drawback (Advanced Materials, vol. 9, pg. 741-746, 1997). For example, the conformal nature of the material makes it “floppy.” Maintaining planarity is impossible if not supported, with manual handling exacerbating the problem. One of the most significant challenges is the large coefficient of thermal expansion of PDMS. Silicones can have CTEs of more than 100 μm/m·K; tests indicate that PDMS might have a higher value, approaching 300 μm/m·K. During the fabrication process, the prepolymer is applied to a master pattern and heated to speed curing. Curing at room temperature may take many days, while heating at 80° C. reduces this time to a couple of hours. This temperature change of 55° C. results in the polymer curing while in an expanded state. When cooled, the elastomeric polymer contracts further than the substrate, becoming smaller by 1-2%.

Other approaches have attempted to solve these problems. U.S. Pat. No. 3,165,569 uses the thermal expansion differences as an advantage to apply pressure with molding parts, but does not consider the effects of precise pattern reproduction. Alternatively, a solid backing can reduce the flexibility of the material, simplifying material handling, as provided in U.S. Pat. No. 6,656,308. However, a solid backing does not solve the thermal issues, except in special cases. If the material is very thin, the backing will hold the elastomer in shape. For thicker materials, the backing will hold one side of the materials, while the relief side will still contract. Effectively, the elastomer slab will take on a trapezoidal cross section. A solution to this issue will enable improved microdevice manufacturing.

An alternative approach to thermal expansion in elastomers is provided in U.S. Pat. No. 4,824,631. In that invention, elastomer shrinking is acknowledged and solved by cutting the material after curing. The pieces can be appropriately resized with the gaps filled with additional prepolymer. This method does not work with micromolding, as cutting and resizing will move the patterns from their original relative positions.

### SUMMARY

In accordance with one embodiment, the present invention is a dimensional-stabilizing fixture comprising a vessel into which a liquid elastomeric prepolymer may be cured, maintaining material size and geometry after the curing process within the vessel. The prepolymer may be cast against a master pattern to create a relief pattern in the final polymer.

In a preferred embodiment, the fixture comprises a ring 110 of material with an internal flange 116 perpendicular to the internal surface of the ring 110. This flange 116 provides additional surface area for the elastomeric polymer 415 to contact during the curing process. Furthermore, the fixture may be thermally-matched to a master-patterned substrate so that precise pattern reproduction may occur over a temperature range.

In an additional embodiment, the flange may include structures such as cylindrical pillars or pins perpendicular to the flange. These pillars or pins 114 further increase the surface area to improve elastomer-fixture contact. The large forces induced during a curing process may separate the elastomer 415 from the ring 110; additional surface area increases the contact force to oppose these thermally-induced separation forces. An alternative embodiment may include a roughened surface 116 to increase the surface area and contact force.

An additional embodiment includes grooves 210 or cuts in the fixture, allowing the fixture to flex and bend. These grooves may be cut at varying depths through the fixture to balance flexibility and structural stability. This ability to flex will enable the fixture and cured polymer to separate from the master pattern by a rolling separation instead of planar separation.

Another embodiment includes indexing pins 310 on the fixture. Such pins may align to corresponding holes on another instrument, into which the fixture could then be mounted. This feature would allow the fixture to be precisely positioned for alignment or automation, such as in automatic microcontact printing or automated microfluidic device fabrication.

### DRAWINGS

FIG. 1A is a bottom view of the fixture. The main portion of the ring 110 contains an indent 112 for a sealant material. Inside of the ring are ledges 116 to hold the elastomer during mold release, with vertical structures, shown as cylindrical pins 114, to further hold the elastomer.

FIG. 1B is a cross-section view through A, with a change in scale for clarity. The ring 110, ledges 114, and vertical holding structures 116 are all indicated.

FIG. 2A is a bottom view of a flexible fixture. The ring 110, ledges 114, and vertical holding structures 116 are indicated. In addition, the grooves 210 to enable flexibility are shown.

FIG. 2B is a cross-section view through A, with a change in scale for clarity. The ring 110, ledges 114, vertical holding structures 116, and grooves 210 are all indicated.

FIG. 3A is a bottom view of the fixture illustrating indexing pins 310.

FIG. 3B is a side view of the fixture indicating the indexing pins 310.

FIG. 4A is a side cross-section view of the fixture, indicating the elastomer 410 cast against a patterned substrate 420 on base plate 430.

FIG. 4B is a side cross-section view of the fixture, illustrating planar separation of the cured polymer 415 from the patterned substrate 420.

FIG. 4C provides a side view of a fixture containing grooves 210, and illustrates rolling separation of the cured polymer 415 from the patterned substrate.

### DETAILED DESCRIPTION

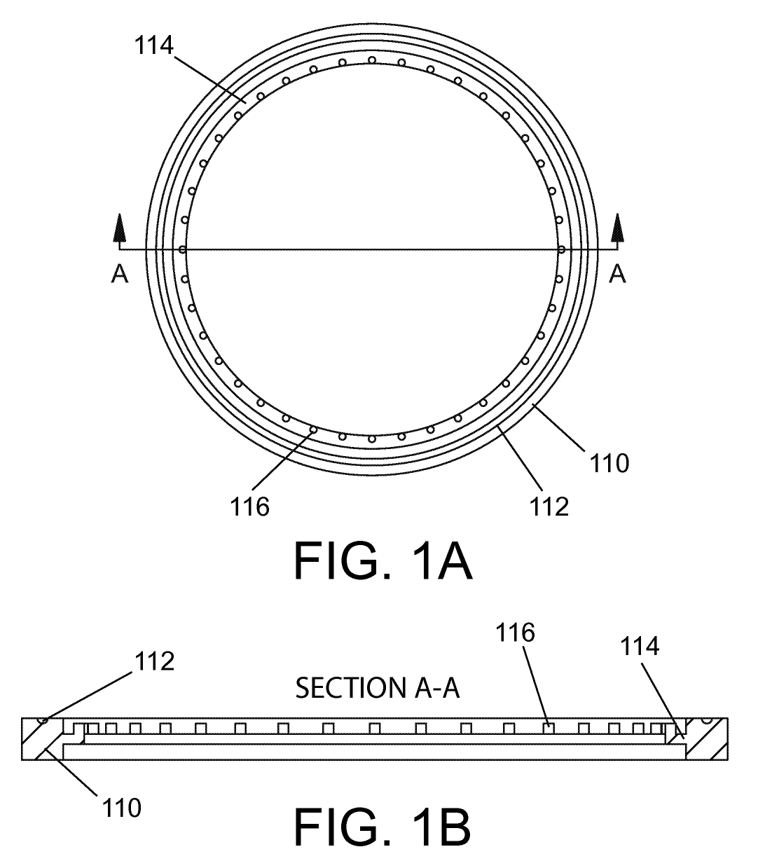

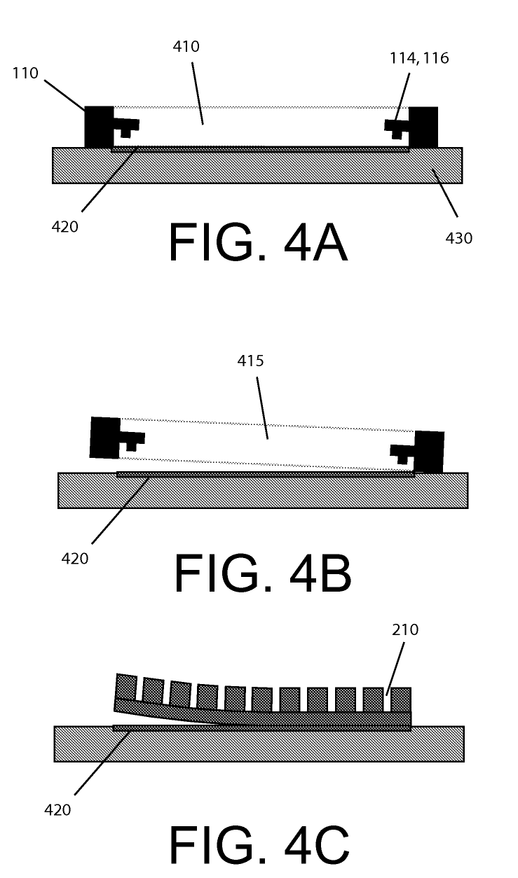

The present invention is the fixture of FIG. 1A to hold elastomeric material during curing. This fixture may be thermally matched to a patterned substrate to maintain dimensions during thermal cycling; such a system is provided in FIG. 4A, illustrating the relative positions of the ring 110, the patterned substrate 420, and the elastomeric prepolymer 410.

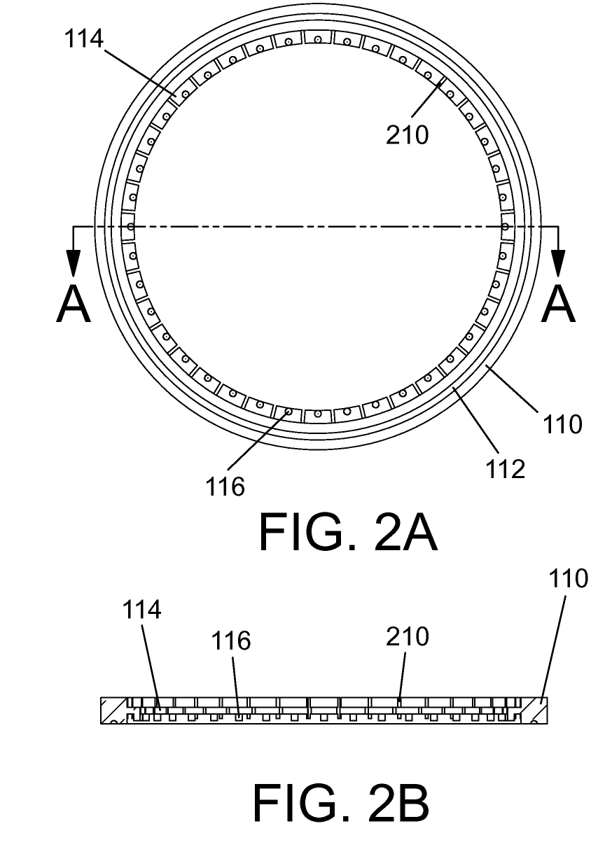

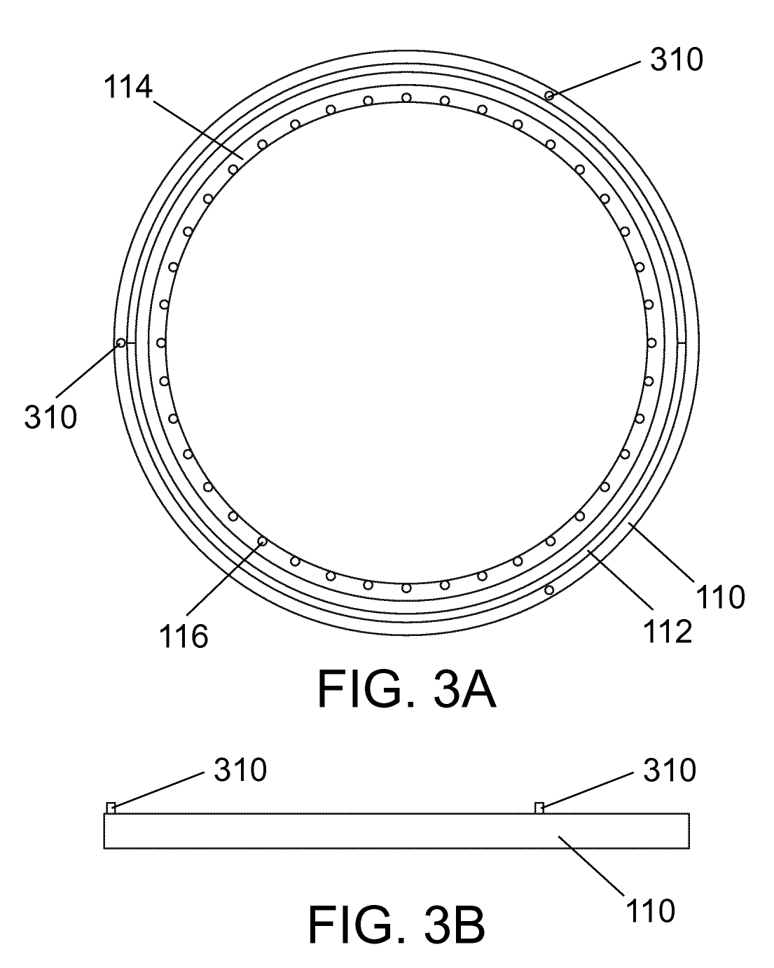

While this type of fixture is a partial solution, a simple ring 110 may not be completely effective. The elastomer may separate from the fixture during temperature cycling or during removal from the master. Thus, the fixture may contain fins 114 and pins 116 to increase the surface area between the ring 110 and the elastomer. Increasing the surface area will decrease the force per unit area induced by thermal cycling the materials. Furthermore, as illustrate in FIG. 2, the fixture can be made flexible using grooves 210 to allow the substrate and wafer to separate with damaging the materials involved. Such a process is shown in FIG. 4C.

A circular design for the ring 110 is used as the material will become stressed after cooling. Without a circular fixture, the tensile stress will lead to uneven stretching of the elastomer. In a preferred embodiment, the inner diameter of the fixture is slightly less than the size of the substrate, allowing a sealing material such as an O-ring to sit between the substrate and the fixture in the sealant groove 112. Such a design matches well with standard round semiconductor wafers.

The fixture is preferably made from a material thermally matched to the master pattern. In the case of a silicon substrate master, the material may be a glass-filled polymer, for example. This material can be injection molded, providing an inexpensive approach to producing large quantities of disposable fixtures.

Advantages of this approach are that it maintains dimensional stability, allows further processing steps without manual handling, and provides a framework to apply backings for cleanliness or handling. The addition of positioning pins 310 may allow the fixture to be mounted in a piece of equipment for further processing steps. Alternatives exist to simple positioning pins, such as using optical encoders with patterns built into the fixture or other geometrical limiters. These steps include, but are not limited to, building a multilayer device or aligned printing.

Removing the cured elastomer from the master presents a challenge, as the force between the two can be large. Direct, parallel separation may be difficult to achieve, as the force will be large. Rotational separation, shown in FIG. 4B is possible by lifting on one side of the fixture. Another approach is to allow the fixture to flex, as shown in FIG. 4C. As one side is lifted, the elastomer and fixture will together roll off the substrate, greatly reducing the force required and the possibility of damage to the elastomer 415 or master 420.

As one skilled in the art will readily appreciate from the disclosure of the embodiments herein, processes, machines, manufacture, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, means, methods, or steps.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

In general, in the following claims, the terms used should not be construed to limit the systems and methods to the specific embodiments disclosed in the specification and the claims, but should be construed to include all systems that operate under the claims. Accordingly, the systems and methods are not limited by the disclosure, but instead the scope of the systems and methods are to be determined entirely by the claims.

What is claimed is:

1. A fixture for manufacturing with elastomeric materials, comprising:
a. a ring of predetermined outer and inner geometry, and
b. an inner void within which a liquid elastomer may be held during polymerization

2. The fixture of claim 1 wherein said ring has at least one internal flange perpendicular to the internal surface of said fixture

3. The fixture of claim 2 wherein said flange has a plurality of structures perpendicular to said flange

4. The fixture of claim 3 wherein said vertical structures are cylindrical in shape

5. The fixture of claim 3 wherein said vertical structures are rectangular in shape

6. The fixture of claim 1 wherein said ring interfaces with a predetermined patterned substrate designed to impart said pattern into said elastomer

7. The fixture of claim 6 wherein said ring has a coefficient of thermal expansion approximately equal to that of said substrate whereby said substrate and said ring will expand equally under temperature changes

8. The fixture of claim 1 wherein said ring is made of metal

9. The fixture of claim 1 wherein said ring is made of plastic

10. The fixture of claim 1 wherein said ring is made of fiber-reinforced polymers

11. A fixture of claim 1 wherein said ring contains slits for allowing said ring to flex

12. A system for manufacturing polymeric devices, comprising:
a. a ring fixture of predetermined outer and inner shapes, and
b. a patterned substrate with predetermined pattern, and
c. whereby said fixture and said polymer have approximately equal coefficients of thermal expansion

13. The system of claim 12 wherein said fixture has at least one internal flange perpendicular to the internal surface of said fixture

14. The fixture of claim 13 wherein said flange has a plurality of structures perpendicular to said flange

15. The fixture of claim 14 wherein said vertical structures are cylindrical in shape

16. The fixture of claim 14 wherein said vertical structures are rectangular in shape

17. The system of claim 13 wherein said fixture contains grooves or slits allowing said fixture to flex
